(19) United States
(12) Patent Application Publication
(10) Pub. No.: US 2025/0280031 A1
(43) Pub. Date: Sep. 4, 2025

(54) ENHANCED SUBSTATION GATEWAY-BASED OPERATIONAL TECHNOLOGY SECURITY MONITORING AND AUTOMATED RESPONSE

(71) Applicant: GE Infrastructure Technology LLC, Greenville, SC (US)

(72) Inventors: Balakrishna PAMULAPARTHY, Hyderabad (IN); Mukesh NARASIMHAN, Hyderabad (IN); Supratik PATHAK, Dubai (AE); Syed Jaffer ALI, Hyderabad (IN)

(73) Assignee: GE Infrastructure Technology LLC, Greenville, SC (US)

(21) Appl. No.: 18/592,314

(22) Filed: Feb. 29, 2024

(51) Int. Cl. H04L 9/40; G06F 9/455

(52) U.S. Cl. CPC H04L 63/1441; G06F 9/45558; H04L 63/1425; G06F 2009/45587; G06F 2009/45595

(57) ABSTRACT

Systems and methods for preventing security attacks with a virtualization of power substations may include identifying, by a virtual system including a first virtual machine connected to an information technology (IT) environment of a power substation network and further comprising a second virtual machine connected to an operational technology (OT) environment of the power substation network, an alert indicative of a potential security attack; retrieving, by the virtual system, based on a memory access shared by the first virtual machine and the second virtual machine, IT analytics data associated with a device indicated in the alert; retrieving, by the virtual system, based on the memory access, OT analytics data associated with the device; comparing, by the virtual system, the IT analytics data and the OT analytics data to a baseline model of the power substation network; and preventing, by the virtual system, communication with the device based on the comparing.

This disclosure generally relates to security monitoring and responses to an integrated information technology-operational technology environment.

### BACKGROUND

As power substations become more digitalized, cybersecurity attacks are a risk to information technology and operational technology environments for power grids. Signature-based detection and response to security threats do not predict device states and actions, and may not monitor network layers of the Open Systems Interconnection (OSI) model.

### SUMMARY

A method for preventing security attacks with a virtualization of power substation physical components into an information technology-operational technology architecture, may include identifying, by a virtual system comprising a first virtual machine connected to an information technology (IT) environment of a power substation network and further comprising a second virtual machine connected to an operational technology (OT) environment of the power substation network, an alert indicative of a potential security attack; retrieving, by the virtual system, using a memory access shared by the first virtual machine and the second virtual machine, IT analytics data associated with a device indicated in the alert; retrieving, by the virtual system, based on the memory access, OT analytics data associated with the device; comparing, by the virtual system, the IT analytics data and the OT analytics data to a baseline IT-OT model of the power substation network, wherein the baseline IT-OT model is based on IT baseline analytics data and OT baseline analytics data shared between the first virtual machine and the second virtual machine by using the memory access; and preventing, by the virtual system, communication with the device based on the comparing.

A non-transitory computer-readable storage medium may include instructions to cause processing circuitry of a virtual system for preventing security attacks of a power substation network, upon execution of the instructions by the processing circuitry, to: identify, by a virtual system comprising a first virtual machine connected to an information technology (IT) environment of a power substation network and further comprising a second virtual machine connected to an operational technology (OT) environment of the power substation network, an alert indicative of a potential security attack; retrieve, by the virtual system, based on a memory access shared by the first virtual machine and the second virtual machine, IT analytics data associated with a device indicated in the alert; retrieve, by the virtual system, based on the memory access, OT analytics data associated with the device; compare, by the virtual system, the IT analytics data and the OT analytics data to a baseline IT-OT model of the power substation network, wherein the baseline IT-OT model is based on IT baseline analytics data and OT baseline analytics data shared between the first virtual machine and the second virtual machine by using the memory access; and prevent, by the virtual system, communication with the device based on the comparing.

A system for preventing security attacks with a virtualization of power substation physical components into an information technology-operational technology architecture, the system may include: a virtual system comprising a first virtual machine connected to an information technology (IT) environment of a power substation network and further comprising a second virtual machine connected to an operational technology (OT) environment of the power substation network; and memory coupled to processing circuitry, wherein the processing circuitry is configured to: identify, by the virtual system, an alert indicative of a potential security attack; retrieve, by the virtual system, based on a memory access shared by the first virtual machine and the second virtual machine, IT analytics data associated with a device indicated in the alert; retrieve, by the virtual system, based on the memory access, OT analytics data associated with the device; compare, by the virtual system, the IT analytics data and the OT analytics data to a baseline IT-OT model of the power substation network, wherein the baseline IT-OT model is based on IT baseline analytics data and OT baseline analytics data shared between the first virtual machine and the second virtual machine by using the memory access; and prevent, by the virtual system, communication with the device based on the comparing.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is an example diagram representing virtualization of power substation physical components into an information technology-operational technology architecture with a shared memory in accordance with one embodiment of the present disclosure.

FIG. 2 is an example architecture for preventing a new node in a network based on the information technology-operational technology architecture of FIG. 1 in accordance with one embodiment of the present disclosure.

FIG. 3 is an example architecture for preventing a new communication link in a network based on the information technology-operational technology architecture of FIG. 1 in accordance with one embodiment of the present disclosure.

FIG. 4 is an example architecture for preventing a new communication protocol in a network based on the information technology-operational technology architecture of FIG. 1 in accordance with one embodiment of the present disclosure.

FIG. 5 is an example architecture for preventing an incorrect signal synchronization in a network based on the information technology-operational technology architecture of FIG. 1 in accordance with one embodiment of the present disclosure.

FIG. 6 is a flow for a process for preventing security attacks with a virtualization of power substation physical components into an information technology-operational technology architecture in accordance with one embodiment of the present disclosure.

FIG. 7 is a diagram illustrating an example of a computing system that may be used in implementing embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Many critical infrastructure assets, such as power plants, transmission and distribution networks, transportation systems and water processing plants, are efficiently and safely operated using control systems. Such control systems act as the “brains” of the plant or asset reading information from sensors and sending command signals to actuators. Control systems are also critical subsystems in mobile assets such as aircraft, automobiles and even locomotives. However, these same critical control systems are now the focus of sophisticated cyber-attacks.

Digitalization of power grids may integrate operational technology (OT) with information technology (IT) infrastructures. For example, IT may represent substation gateways, engineering workstations, human machine interfaces (HMIs), supervisory control and data acquisition (SCADA) systems, databases, engineering servers, authentication servers, access control servers, and surveillance system servers. OT may represent a communication network (e.g., governed by the IEC 61850 standard) hardware, including protection devices, gateways, intelligent electronic devices (IEDs), control units, measurement and merging units, and other power grid devices.

One type of cyber security attack on such infrastructure includes a manipulation of device values. To perform such an attack, an attacker needs access to the internal network of a customer environment, access to a device in the targeted network, privileged access to manipulate the device output and affect a normal process, and to manipulate system logs to hide the related sequence of events from an incident response team.

To prevent such cyber-attacks, there should be strong inventory management and management of devices, such as timely patch updates and performance of risk assessments. Preventing end device manipulation is crucial.

There is therefore a need to secure OT-IT infrastructure from manipulation of values that result in blackouts. The enhanced prevention herein may be achieved by using a network intrusion detection system for asset information gathering, which may be further enhanced as described herein for attack prevention.

In one or more embodiments, a network intrusion detection system (NIDS) functionality may be enhanced by using a digital ghost solution to prevent addition of new devices to a network (e.g., using Zero Trust). If the state of an electrical breaker or a value of final element is not in a desired state/value per the logical and physical dynamics, the breaker's related loop may be validated against the smart network intrusion detection system to validate if any bypass operation is performed. Any configuration change may be blocked by the digital ghost solution. Manual time synchronization to the devices may be blocked once the network intrusion detection system has allowed the geo-location of time-synchronized devices.

In contrast, existing network intrusion detection systems operate as monitoring tools rather than as predictive and preventative tools. For example, existing network intrusion detection systems may alert an operator that something in the system is malicious and that there is a possible compromise in the network or host. Intrusion prevention systems may not be feasible in an environment in which data transfer is at milliseconds speed, such as a power substation infrastructure. The frequency of data exchange between intelligent electronic devices (IEDs) and substation gateways may prevent the practical use of intrusion prevention systems.

In one or more embodiments, the enhanced smart network intrusion detection system herein may maintain an updated asset inventory by enabling auto-discovery of a device and its type in a substation network, may identify malicious activity in digital substations at the OT level, and may perform auto-identification of device settings changes from baseline configurations.

In one or more embodiments, the network intrusion detection system herein may be connected to a root switch of an infrastructure, and all network traffic from the root switch may be monitored by the network intrusion detection system using a mirror port. Once the network intrusion detection system device is on-boarded, the network intrusion detection system device may gather all network traffic and identify network assets, protocols used, zones, device identifiers (e.g., medium access control identifiers), and the like, to identify a network topology. By using the medium access control (MAC) identifier, and using traffic, a device manufacturer and model of a device may be identified by the network intrusion detection system. This information may be stored at the network intrusion detection system device as a baseline configuration file.

The critical assets in today's power plants, such as gas turbines, are governed by physics, which may be leveraged to create “Digital Twins” of these machines. A digital ghost may use the Digital Twins, knowledge of the associated control systems, and very advanced artificial intelligence algorithms to continuously monitor the asset's behavior. The digital ghost may resides beyond IT/OT firewalls, inside the industrial control system itself. The digital ghost may use a network of sensors, controls and key insights from AI-driven digital twins of key assets to continuously monitor and when necessary, enable real-time actions to thwart cyber threats.

The digital ghost as an upper OSI layer may represent a system that emulates the actual or main system, and may include a copy of the components of a digital twin. The ghost system may also be responsible for verifying if requests made to an installation are secure. In the event of a security threat, the ghost system may be able to detect a cyber-attack, and subsequently delay a cyber-attacker by simultaneously activating various installation alarms and/or automatically disconnecting the remote connections (e.g., Ethernet network connections) to inhibit access by the cyber-attacker to the installation. An automatic sequence of actions can also take complementary actions to allow the controls of one or more installation components (e.g., such as disconnectors and circuit breakers) to be implemented via one or more respective serial communication ports existing in such components. After the main system is considered secure, the main system can be recovered automatically, or can be recovered under operator request using the one or more serial communication channels.

In one or more embodiments, the digital ghost as an application programming interface (API) in a substation gateway may use the baseline configuration file to generate an approved list of equipment in a customer's infrastructure. The devices and communication protocols of the approved list may be frozen, and no new protocols or devices may be added to the network unless first approved. The approved list provides enhanced security by adding a layer of defense in securing the network from newer attack devices and protocols. The enhancements herein go a step further to integrate physical aspects of primary/secondary protection devices. The loops of the devices may be monitored continuously by the digital ghost to predict the stable and desired state of the devices. One example use case is when an attacker breaks into the environment and attempts to manipulate devices values and/or device states. When a new device is to be added to the approved list or a new communication protocol is to be added to an approved device, a confirmation with a multi-factor authentication may be used to prove authenticity of the change/addition. Once a configuration change needs to be deployed, a request from the enhanced tool may reach the gateway, and a hardware token key may be required to authenticate the request.

One scenario may include a new node appearing in a network. Instead of simply notifying an operator of the new node, the digital ghost may use the baseline configuration to predict and proactively block unexpected communications. Another scenario may include a new communication link in a network. The gateway may proactively monitor physical attributes of the source and destination devices for the link to predict and proactively block unexpected communications using the link. Another scenario may include a new protocol in the network, which may be different from an existing (e.g., approved) protocol. The gateway may monitor physical conditions to predict and proactively block unexpected communications. Another scenario may include a wrong time (e.g., a client device reports the wrong time in the network). Substation-level timing events may be logged, and prevention of tampering with log events is important to prevent covering up a cyber-attack. A time synchronization based on a global positioning system (GPS) signal may be used to stop an incorrect GPS signal synchronization, requiring multi-factor authentication to continue. In this manner, the enhanced techniques of the digital ghost herein may use anomaly-based context instead of signature-based context to predict and block unexpected actions and states.

In one or more embodiments, to facilitate the enhancements, the system architecture for IT-OT infrastructure may be leveraged. An first virtual machine may be in the IT environment, and a second virtual machine may be in the OT environment. An inter process communication (IPC)/shared memory between the first and second virtual machines allows information to be exchanged between the IT and OT environments, allowing for OSI layer monitoring (e.g., as opposed to application layer or outside layer monitoring).

In one or more embodiments, the digital ghost may be implemented at a substation gateway, server, or the like, of a substation network. The digital ghost may operate at a lower layer (e.g., network/transport layer), and may model the network assets at the upper OSI layers.

The enhancements herein include real-time anomaly-based monitoring and detection of cyber assets for improved grid management, monitoring of OSI network layers, improved cyber modeling and predictive actions by using the OT infrastructure, reduction in cyber interruptions and risks, reduced volume of data utilities needed for processing with attendant communication, and reduced computational bandwidth needed.

In one or more embodiments, the baselining for the IT and OT networks each may use machine learning-based algorithms, separately, to baseline the IT network and then baseline the OT network. For example, the OT network may leverage domain knowledge of electrical, operational parameters, configurations, logical connections between assets, device details and applications, substation control hierarchy, and the like (e.g., using data available in a gateway) to generate the IT-OT baseline model for the substation network. In this manner, the baseline may be learned by monitoring IT and OT data to identify possible security attacks proactively.

The above descriptions are for purposes of illustration and are not meant to be limiting. Numerous other examples, configurations, processes, etc., may exist, some of which are described in greater detail below. Example embodiments will now be described with reference to the accompanying figures.

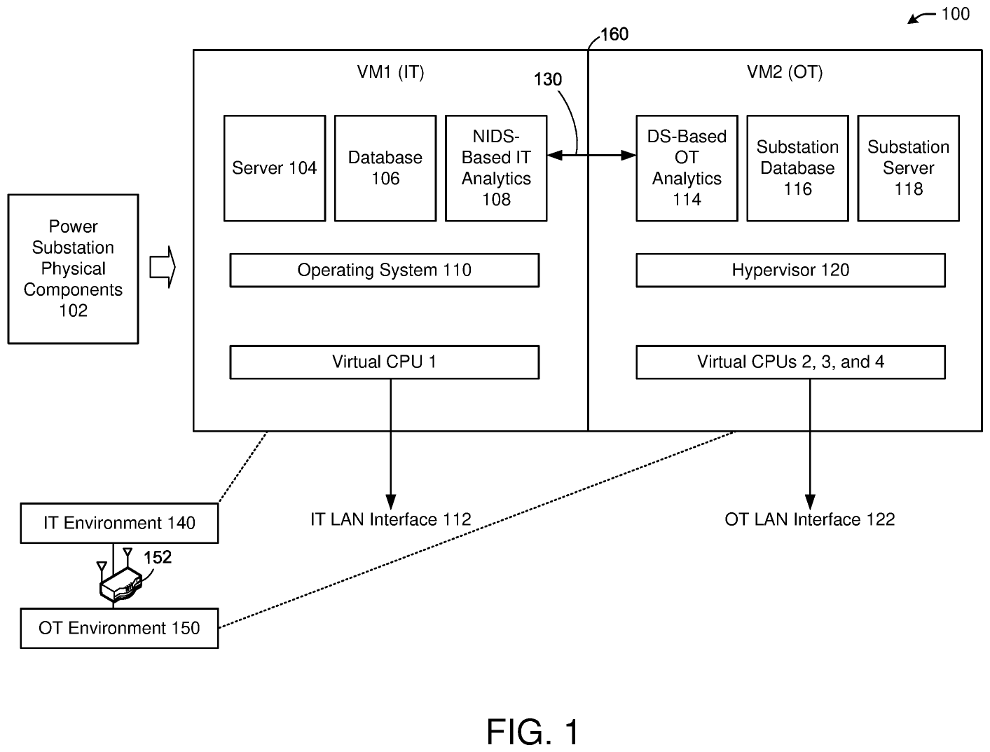

FIG. 1 is an example diagram 100 representing virtualization of power substation physical components into an information technology-operational technology architecture with a shared memory in accordance with one embodiment of the present disclosure.

Referring to FIG. 1, power substation physical components 102 (e.g., intelligent electronic devices, controllers, relays, etc.) may be modeled as virtual (e.g., software) devices at virtual machines (e.g., VM1 for IT infrastructure, and VM2 for OT infrastructure). The virtualization of the power substation physical components 102 may represent IT and OT for the power substation physical components 102. The VM1 for IT components may include a server 104 (e.g., a SCADA server), a database 106 (e.g., a SCADA database), NIDS-based IT analytics 108, an operating system 110, a virtual CPU 1, and may communicate via an IT local area network (LAN) interface 112. The VM2 for the OT components may include detection system (DS)-based OT analytics 114, a substation database 116, a substation server 118, a hypervisor 120, virtual CPUs 2, 3, and 4, and may communicate via an OT LAN interface 122. VM1 and VM2 may use an IPC/shared memory 130 to combine OT and IT analytics for a cyber-physical analysis of the power substation physical components 102.

Still referring to FIG. 1, an IT environment 140 and an OT environment 150 may be separated by and communicate through a gateway 152 (or other device) with which to isolate the IT environment 140 from the OT environment 150. The IT environment 140 may represent substation gateways, engineering workstations, HMIs, SCADA systems, databases, engineering servers, authentication servers, access control servers, and surveillance system servers. The OT environment 150 may represent a communication network (e.g., governed by the IEC 61850 standard) hardware, including protection devices, gateways, intelligent electronic devices (IEDs), control units, measurement and merging units, and other power grid devices. VM1 may connect to the IT environment 140, and VM2 may connect to the OT environment 150. In this manner, the VMs each may be individually connected to the IT environment 140 or the OT environment 150 (e.g., using a network interface controller card). VM1 for IT may run NIDS logic with an IT network model, and VM2 for OT may run logic with an OT network model. The NIDS logic may create the baseline model from the perspective of IT LAN/WAN interfaces, communication protocols/ports accessed, network traffic flows, and other components (e.g., IEDs in VM1). The model file generated by NIDS logic may be shared with VM2, and used to create an OT baseline on top of the IT baseline including core functionality of devices and device profiles (e.g., including firmware version, device model, device voltages/currents/measurements, device logical connections, device settings/configurations, device security, and device environment data).

In one or more embodiments, VM1 and VM2 may represent a virtualized system 160 (e.g., as a substation gateway, server, or the like) for monitoring the power substation physical components 102. By monitoring both OT and IT data, both physical and cybersecurity threats of the power substation physical components 102 may be predicted and prevented.

In one or more embodiments, the virtualized system 160 may monitor the OSI layer of the virtualized system 160 (e.g., as opposed to the application layer or outer layers) to identify security risks for hardware additions, protocol additions, link additions, and time synchronizations.

In one or more embodiments, the hypervisor 120 may facilitate intra-VM communications for VM2. The IPC/shared memory 130 allows inter-VM communications between VM1 and VM2 so that the virtualized system 160 may monitor both IT and OT data of the power substation physical components 102.

In one or more embodiments, VM1 on the IT side may generate baselines for communication network statistics, port usage, network topology, network connections, device communications protocols, security rules and mechanisms, IT server configuration settings, minimum/maximum/average traffic on respective communication links, access control mechanisms, IT operator hierarchies, IT asset identifier lists, and the like, to derive IT baseline analytics using machine learning-based algorithms.

In one or more embodiments, VM2 on the OT side may generate baselines for substation design and architecture, station and process bus topology, device connections and functionality, device settings, device operational rules and mechanisms, OT server configuration settings, substation control hierarchy, substation operational rules, device times, access control mechanisms, OT operator hierarchies, OT asset identifier lists, and the like, to derive OT baseline analytics using machine learning-based algorithms. The IT baseline analytics and the OT baseline analytics may be shared between VM1 and VM2 using the IPC/shared memory 130 to facilitate generation of a common substation IT-OT convergence baseline analytics correlation model.

In one or more embodiments, VM1 on the IT side may monitor, in real-time, communication network statistics, ports usage, network topology, network connections, device communication protocols, security rules and mechanisms, IT server configuration settings, minimum/maximum/average traffic on respective links, access control mechanisms, IT operators hierarchy, IT assets identifier list, and the like, to derive IT operational analytics using machine learning-based algorithms.

In one or more embodiments, VM2 on the OT side may monitor, in real-time, substation design and architecture, station and process bus topology, device connections and their functionality, device settings, device operational rules and mechanisms, OT server configuration settings, substation control hierarchy, substation operational rules, device times, access control mechanisms, OT operators hierarchy, OT assets identifier lists, and the like, to derive OT operational analytics using machine learning-based algorithms. The IT operational analytics and the OT operational analytics may be shared between VM1 and VM2 using the IPC/shared memory 130 to facilitate generation of a common substation IT-OT convergence operational analytics correlation model during each respective computational interval (e.g., the model may update).

In one or more embodiments, comparing, analyzing, and correlating the substation IT-OT convergence operational analytics model with the substation IT-OT convergence baseline analytics model during respective computational intervals allows for identifying deviations in device operations, communications, and time synchronizations with respect to the baselines. When deviations are identified, communications with an unauthorized device or system may be prevented, and alarms may be generated to signal unauthorized devices and communications.

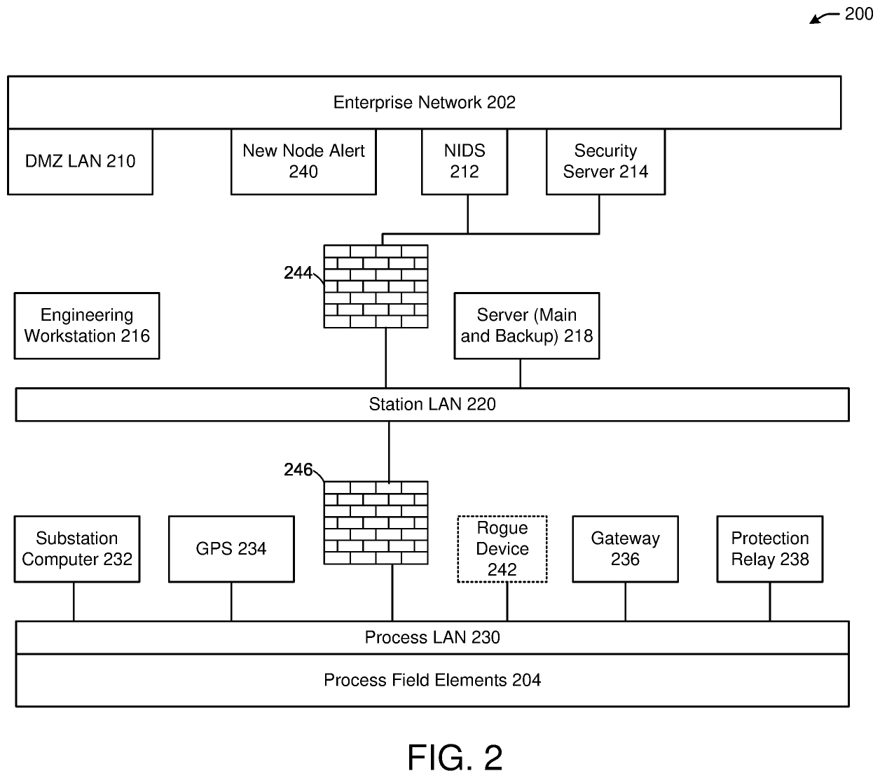

FIG. 2 is an example architecture 200 for preventing a new node in a network based on the information technology-operational technology architecture of FIG. 1 in accordance with one embodiment of the present disclosure.

Referring to FIG. 2, the architecture 200 may include an enterprise network 202 and process field elements 204 (e.g., the power substation physical components 102 of FIG. 1), a demilitarized zone network (DMZ) LAN 210, a NIDS 212, a security server 214, an engineering workstation 216, and a server 218 (e.g., main and backup server for the IT environment 206). The NIDS 212, the security server 214, the engineering workstation 216, and the server 218 may communicate via a station LAN 220. The architecture 200 also may include a process LAN 230 for communicating (e.g., with the station LAN 220), a substation computer 232, a global positioning system (GPS) 234, a gateway 236, and a protection relay 238.

Still referring to FIG. 2, when a new or previously unseen node appears in a network and tries to associate to the network and send data within or outside the network, the NIDS 212 may detect the new node and generate a new node alert 240 for the virtualized system 160 of FIG. 1 (e.g., implemented in the gateway 236 or elsewhere). The new node alert 240 may include details such as which network the new source node is associated with, its corresponding MAC address, protocols used, and destination device (e.g., rogue device 242) with which the new source node is attempting to communicate. When the NIDS 212 alerts the virtualized system 160, the virtualized system 160 may analyze the physical attributes of the destination device to ensure that all parameters are in a healthy condition, and may bypass the system from taking any action from the reported new source node until clearance has been provided to add the source node to the approved list as an approved device (e.g., after multi-factor authentication of the new source node). Until the source node has been approved, any packets sent by the source node may be dropped or black-holed. The NIDS 212 and the security server 214 may communicate with the station LAN 220 via a firewall 244, and the station LAN 220 may communicate with the process LAN 230 via a firewall 246.

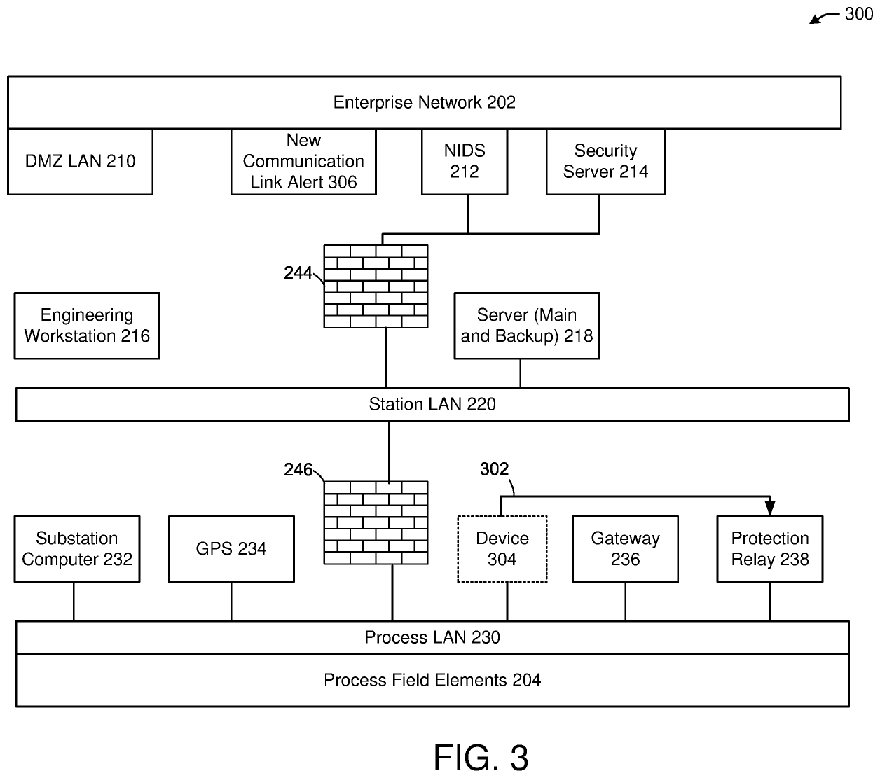

FIG. 3 is an example architecture 300 for preventing a new communication link in a network based on the information technology-operational technology architecture of FIG. 1 in accordance with one embodiment of the present disclosure.

Referring to FIG. 3, the architecture 300 may include the architecture 200 of FIG. 2. The NIDS 212 may detect a new communication link between a source node and destination node (e.g., a communication link 302 from a device 304 and the protection relay 238), and may generate a new communication link alert 306 for the virtualized system 160 (e.g., implemented in the gateway 236 or elsewhere). The new communication link may be between devices in a same network or in different networks, and may be the first such attempt since the baseline was established. When the new communication link alert 306 is triggered, it is important to ensure that the source and destination nodes are under logical control and that the new communication link alert 306 is initiated from authorized operations (e.g., to prevent an attack).

In one or more embodiments, the new communication link alert 306 may indicate the link along with the source and destination nodes. The virtualized system 160 may proactively monitor the physical attributes of the source and destination nodes (e.g., devices) to ensure that all parameters are in healthy condition, and may bypass the system from taking any action from the reported source node until the communication link 302 is declared valid.

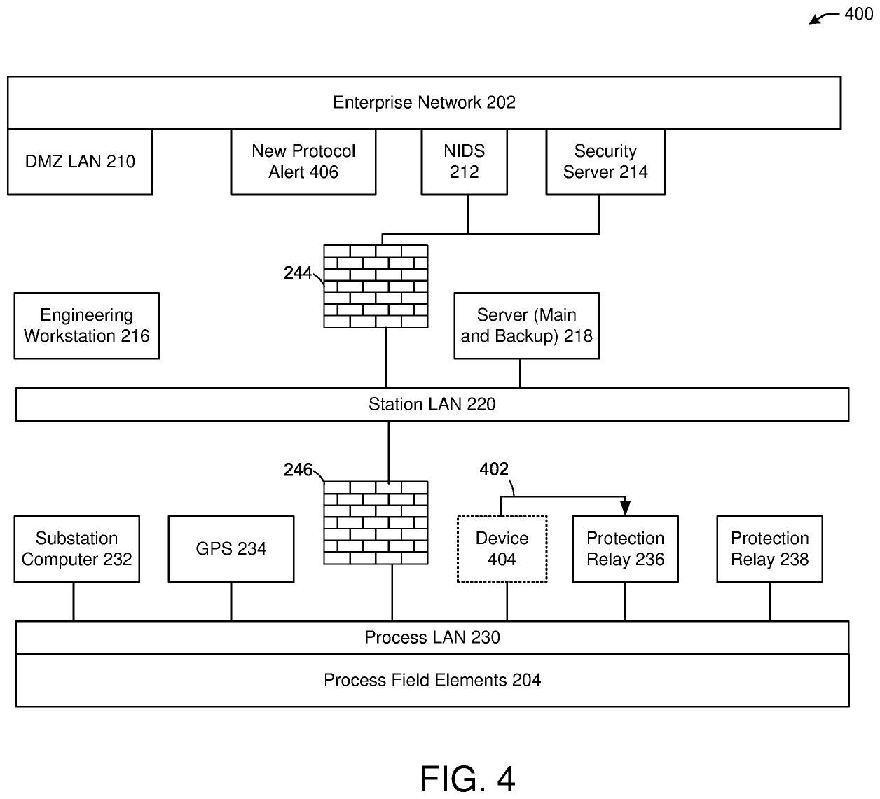

FIG. 4 is an example architecture 400 for preventing a new communication protocol in a network based on the information technology-operational technology architecture of FIG. 1 in accordance with one embodiment of the present disclosure.

Referring to FIG. 4, the architecture 400 may include the architecture 200 of FIG. 2. The NIDS 212 may detect a new or previously unseen protocol used by devices in the system to transfer data packets (e.g., a protocol 402 used by device 404 to communicate with the protection relay 238). When the new or previously unseen protocol is detected, the NIDS 212 may generate a new protocol alert 406 (e.g., implemented in the gateway 236 or elsewhere) to alert the virtualized system 160 of FIG. 1. A new protocol may be introduced based on a requirement (e.g., security update) or by an attacker to listen to a communication and process its values.

In one or more embodiments, the new protocol alert 406 may indicate which protocol is detected, along with the source and destination nodes (e.g., devices) using the protocol. The details also may include which device initiated the new protocol request, its corresponding MAC address, protocol initiation time, destination device that the source device is attempting to reach, and the like. In response to the new protocol alert 406, the virtualized system 160 may proactively monitor physical attributes of the source device to ensure that all parameters are in healthy condition, and override any action triggered by the source device until the source device is declared legitimate upon review.

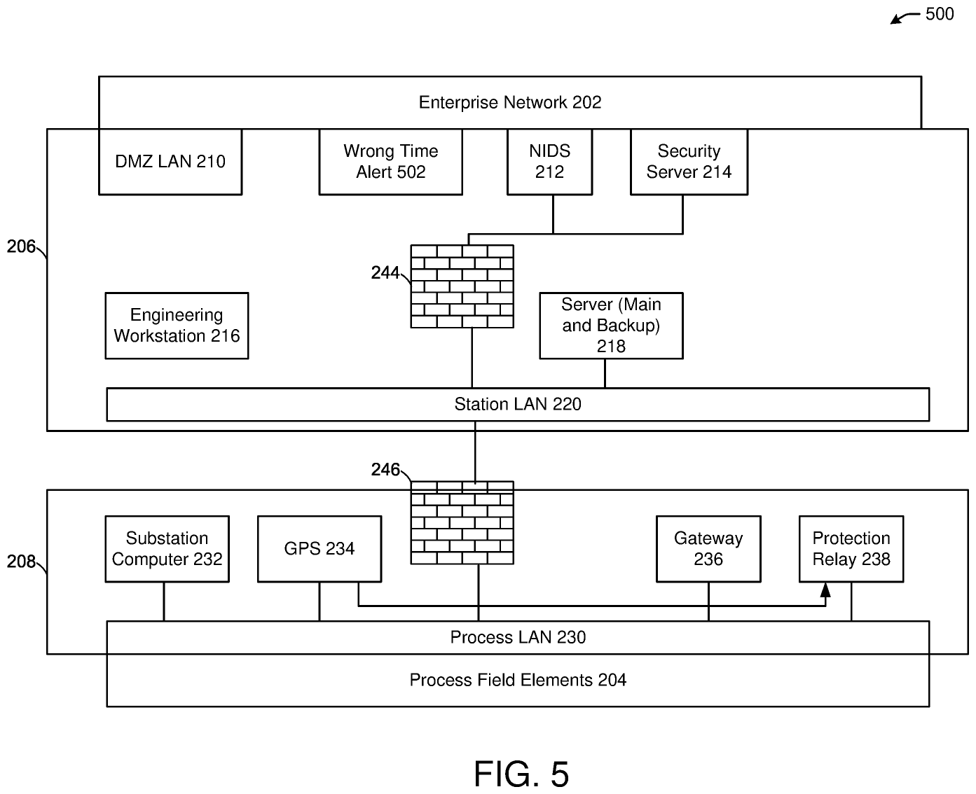

FIG. 5 is an example architecture 500 for preventing an incorrect signal synchronization in a network based on the information technology-operational technology architecture of FIG. 1 in accordance with one embodiment of the present disclosure.

Referring to FIG. 5, the architecture 500 may include the architecture 200 of FIG. 2. The NIDS 212 may detect a wrong time reported in the system (e.g., for the protection relay 238). For example, a device may report a wrong time due to incorrect time synchronization, a change in master clock time, or a security compromise of the device. At a substation level, the time synchronization of all devices is critical because when a device is not synchronized, an attacker has an advantage of emulating an attack using incorrect security event timestamps, undermining the ability of a forensics team to correlate a sequence of events that triggered a blackout. For example, there may be a GPS configuration change in the protection relay 238 or an addition of a rogue GPS in the architecture 500. As a result, the NIDS 212 may generate a wrong time alert 502 to alert the virtualized system 160 (e.g., implemented in the gateway 236 or elsewhere).

In one or more embodiments, the wrong time alert 502 may indicate the incorrect time and the device that reported the incorrect time. In response, the virtualized system 160 may proactively monitor the physical attributes of the source device to ensure healthy parameters. An override preventing communications with the source device may be enabled until it may be determined that the synchronization issue is due to a loss of GPS signal or similar event, and has been corrected, before the override may be disabled.

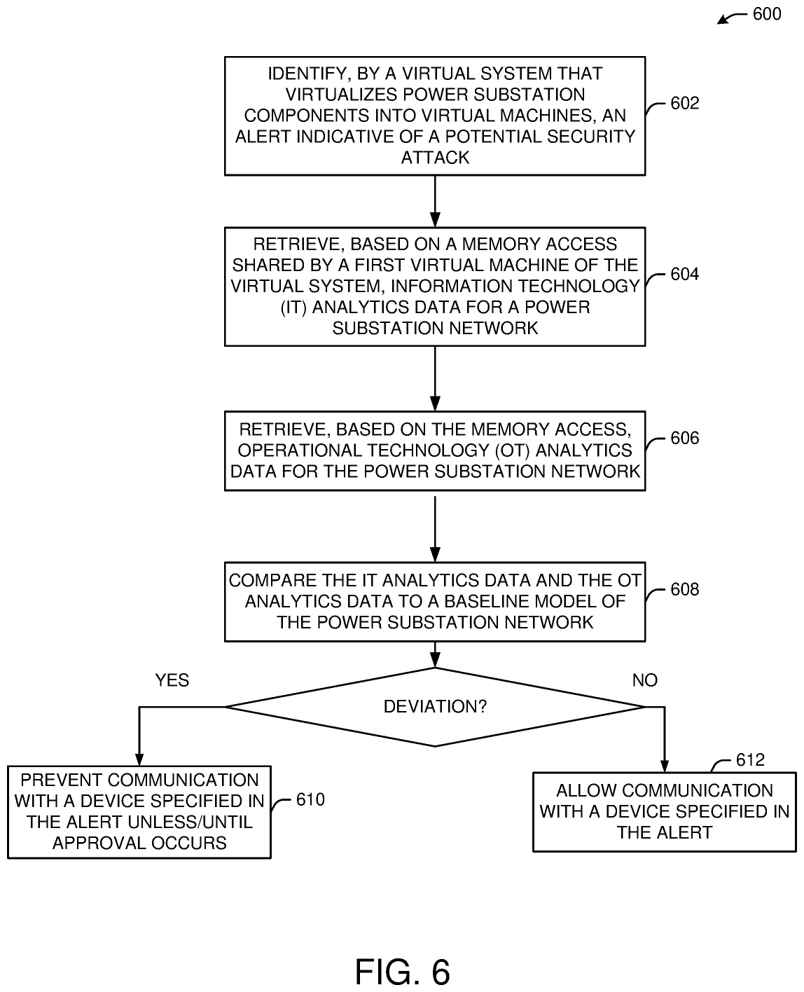

FIG. 6 is a flow for a process 600 for preventing security attacks with a virtualization of power substation physical components into an information technology-operational technology architecture in accordance with one embodiment of the present disclosure.

At block 602, a device (or system, e.g., the virtualized system 160 of FIG. 1) may identify an alert of a potential security attack in a power substation network. The alert may be a new node/device alert, a new communication link alert, a new protocol alert, or a wrong time alert. In response to the alert, the device may analyze IT and OT data of any devices specified in the alert. The architecture used by the device may include a first VM connected to an IT infrastructure, and a second VM connected to an OT infrastructure. The IT and OT infrastructures may be separated from one another, but the first and second VMs may use a shared memory access to facilitate baselining and analysis of IT-OT analytics data.

At block 604, the device may use the shared memory access between an IT virtual machine and an OT virtual machine to retrieve IT analytics data for the power substation network. At block 606, the device may use the shared memory access to retrieve OT analytics data for the power substation network. The device may generate an IT-OT baseline model and an IT-OT operational model. The VM on on the IT side may generate baselines for communication network statistics, port usage, network topology, network connections, device communications protocols, security rules and mechanisms, IT server configuration settings, minimum/maximum/average traffic on respective communication links, access control mechanisms, IT operator hierarchies, IT asset identifier lists, and the like, to derive IT baseline analytics using machine learning-based algorithms. The VM on the OT side may generate baselines for substation design and architecture, station and process bus topology, device connections and functionality, device settings, device operational rules and mechanisms, OT server configuration settings, substation control hierarchy, substation operational rules, device times, access control mechanisms, OT operator hierarchies, OT asset identifier lists, and the like, to derive OT baseline analytics using machine learning-based algorithms. The IT baseline analytics and the OT baseline analytics may be shared between the two VMs using the IPC/shared memory 130 to facilitate generation of a common substation IT-OT convergence baseline analytics correlation model.

The VM on the IT side may monitor, in real-time, communication network statistics, ports usage, network topology, network connections, device communication protocols, security rules and mechanisms, IT server configuration settings, minimum/maximum/average traffic on respective links, access control mechanisms, IT operators hierarchy, IT assets identifier list, and the like, to derive IT operational analytics using machine learning-based algorithms.

The VM on the OT side may monitor, in real-time, substation design and architecture, station and process bus topology, device connections and their functionality, device settings, device operational rules and mechanisms, OT server configuration settings, substation control hierarchy, substation operational rules, device times, access control mechanisms, OT operators hierarchy, OT assets identifier lists, and the like, to derive OT operational analytics using machine learning-based algorithms. The IT operational analytics and the OT operational analytics may be shared between the VMs using the IPC/shared memory 130 to facilitate generation of a common substation IT-OT convergence operational analytics correlation model during each respective computational interval (e.g., the model may update).

A NIDS logic run by the first VM may be used to create a baseline model for the substation network from the perspective of IT LAN/WAN interfaces, communication protocols, ports being accessed, network traffic flows, and other components such as IEDs. The model may be shared with the second VM to add the OT baseline on top of the IT baseline model to create an IT-OT baseline model. The attributes in the IT-OT baseline model may include physical attributes such as ports, service, protocols, and the like, in addition to the IT attributes. For example, the baseline model may be based on IT area network interfaces, communication protocols, accessed ports, network traffic flows, device functionality, and device profiles as described herein.

At block 608, the device may compare the IT and OT analytics data to the baseline IT-OT model (e.g., by generating the IT-OT operational analytics model) to determine whether there is a deviation (e.g., by a threshold amount) from the baseline IT-OT model indicative of a potential attack. When the IT and/or OT analytics data deviate (e.g., by a threshold amount) from the baseline, at block 610, the device may prevent communications with any device specified in the alert unless or until the device, a protocol used by the device, link used by the device, or wrong time reported by the device, have been analyzed and approved (e.g., using multi-factor authentication of the device). At block 612, when the IT and OT analytics data do not deviate (e.g., by a threshold amount) from the baseline, communication with the device specified in the alert may be allowed.

It is understood that the above descriptions are for purposes of illustration and are not meant to be limiting.

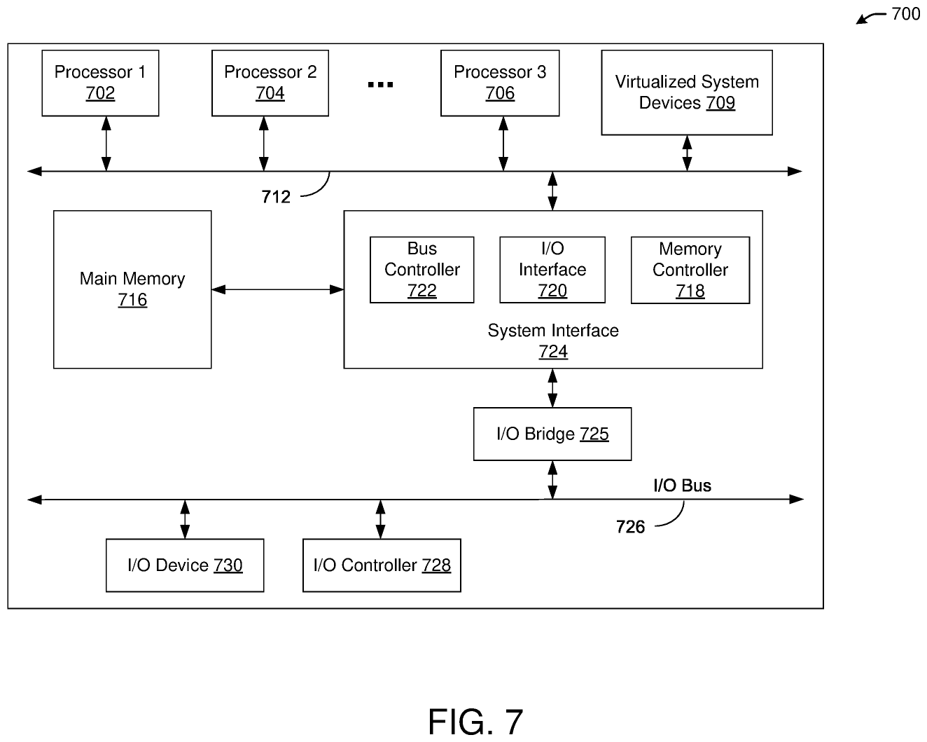

FIG. 7 is a diagram illustrating an example of a computing system 700 that may be used in implementing embodiments of the present disclosure.

The computer system 700 (system) includes one or more processors 702-706 and virtualized system devices 709 (e.g., representing at least a portion of the virtualized system 160 of FIG. 1). Processors 702-706 may include one or more internal levels of cache (not shown) and a bus controller 722 or bus interface unit to direct interaction with the processor bus 712. Processor bus 712, also known as the host bus or the front side bus, may be used to couple the processors 702-706 with the system interface 724. System interface 724 may be connected to the processor bus 712 to interface other components of the system 700 with the processor bus 712. For example, system interface 724 may include a memory controller 718 for interfacing a main memory 716 with the processor bus 712. The main memory 716 typically includes one or more memory cards and a control circuit (not shown). System interface 724 may also include an input/output (I/O) interface 720 to interface one or more I/O bridges 725 or I/O devices with the processor bus 712. One or more I/O controllers and/or I/O devices may be connected with the I/O bus 726, such as I/O controller 728 and I/O device 730, as illustrated.

I/O device 730 may also include an input device (not shown), such as an alphanumeric input device, including alphanumeric and other keys for communicating information and/or command selections to the processors 702-706. Another type of user input device includes cursor control, such as a mouse, a trackball, or cursor direction keys for communicating direction information and command selections to the processors 702-706 and for controlling cursor movement on the display device.

System 700 may include a dynamic storage device, referred to as main memory 716, or a random access memory (RAM) or other computer-readable devices coupled to the processor bus 712 for storing information and instructions to be executed by the processors 702-706. Main memory 716 also may be used for storing temporary variables or other intermediate information during execution of instructions by the processors 702-706. System 700 may include a read only memory (ROM) and/or other static storage device coupled to the processor bus 712 for storing static information and instructions for the processors 702-706. The system outlined in FIG. 7 is but one possible example of a computer system that may employ or be configured in accordance with aspects of the present disclosure.

According to one embodiment, the above techniques may be performed by computer system 700 in response to processor 704 executing one or more sequences of one or more instructions contained in main memory 716. These instructions may be read into main memory 716 from another machine-readable medium, such as a storage device. Execution of the sequences of instructions contained in main memory 716 may cause processors 702-706 to perform the process steps described herein. In alternative embodiments, circuitry may be used in place of or in combination with the software instructions. Thus, embodiments of the present disclosure may include both hardware and software components.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, or a report writing language. In one or more example embodiments, a software component comprising instructions in one of the foregoing examples of programming languages may be executed directly by an operating system or other software component without having to be first transformed into another form.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language. Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in any applicable flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in any flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program module(s), or other data transmitted within a data signal, such as a carrier wave, or other transmission. However, as used herein, CRSM does not include CRCM.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

What is claimed is:

1. A method for preventing security attacks with a virtualization of power substation physical components into an information technology-operational technology architecture, the method comprising:
identifying, by a virtual system comprising a first virtual machine connected to an information technology (IT) environment of a power substation network and further comprising a second virtual machine connected to an operational technology (OT) environment of the power substation network, an alert indicative of a potential security attack;
retrieving, by the virtual system, using a memory access shared by the first virtual machine and the second virtual machine, IT analytics data associated with a device indicated in the alert;
retrieving, by the virtual system, based on the memory access, OT analytics data associated with the device;
comparing, by the virtual system, the IT analytics data and the OT analytics data to a baseline IT-OT model of the power substation network, wherein the baseline IT-OT model is based on IT baseline analytics data and OT baseline analytics data shared between the first virtual machine and the second virtual machine by using the memory access; and
preventing, by the virtual system, communication with the device based on the comparing.

2. The method of claim 1, wherein the alert is a new node alert indicating that the device is new to the power substation network or was previously unidentified in the power substation network.

3. The method of claim 1, wherein the alert is a new communication link alert indicating that the device has requested a new communication link.

4. The method of claim 1, wherein the alert is a new protocol alert indicating that the device is using a protocol that has not been approved for the power substation network.

5. The method of claim 1, wherein the alert is a wrong time alert indicating that the device has reported an incorrect time.

6. The method of claim 1, further comprising:
generating the baseline IT-OT model using IT area network interfaces, communication protocols, accessed ports, network traffic flows, device functionality, and device profiles shared between the first virtual machine and the second virtual machine by using the memory access; and
generating an IT-OT operational analytics model based on the IT analytics data and the OT analytics data,
wherein comparing the IT analytics data and the OT analytics data to the baseline IT-OT model comprises comparing the IT-OT operational analytics model to the baseline IT-OT model.

7. The method of claim 6, wherein the comparing further comprises:
detecting a deviation of the IT-OT operational analytics model from the baseline IT-OT model.

8. A non-transitory computer-readable storage medium comprising instructions to cause processing circuitry of a virtual system for preventing security attacks of a power substation network, upon execution of the instructions by the processing circuitry, to:
identify, by a virtual system comprising a first virtual machine connected to an information technology (IT) environment of a power substation network and further comprising a second virtual machine connected to an operational technology (OT) environment of the power substation network, an alert indicative of a potential security attack;
retrieve, by the virtual system, based on a memory access shared by the first virtual machine and the second virtual machine, IT analytics data associated with a device indicated in the alert;
retrieve, by the virtual system, based on the memory access, OT analytics data associated with the device;
compare, by the virtual system, the IT analytics data and the OT analytics data to a baseline IT-OT model of the power substation network, wherein the baseline IT-OT model is based on IT baseline analytics data and OT baseline analytics data shared between the first virtual machine and the second virtual machine by using the memory access; and
prevent, by the virtual system, communication with the device based on the comparing.

9. The non-transitory computer-readable storage medium of claim 8, wherein the alert is a new node alert indicating that the device is new to the power substation network or was previously unidentified in the power substation network.

10. The non-transitory computer-readable storage medium of claim 8, wherein the alert is a new communication link alert indicating that the device has requested a new communication link.

11. The non-transitory computer-readable storage medium of claim 8, wherein the alert is a new protocol alert indicating that the device is using a protocol that has not been approved for the power substation network.

12. The non-transitory computer-readable storage medium of claim 8, wherein the alert is a wrong time alert indicating that the device has reported an incorrect time.

13. The non-transitory computer-readable storage medium of claim 8, wherein execution of the instructions further causes the processing circuitry to:
generate the IT-OT baseline model using IT area network interfaces, communication protocols, accessed ports, network traffic flows, device functionality, and device profiles shared between the first virtual machine and the second virtual machine by using the memory access; and
generate an IT-OT operational analytics model based on the IT analytics data and the OT analytics data,
wherein to compare the IT analytics data and the OT analytics data to the baseline IT-OT model comprises to compare the IT-OT operational analytics model to the baseline IT-OT model.

14. The non-transitory computer-readable storage medium of claim 13, to compare further causes the processing circuitry to:
detect a deviation of IT-OT operational analytics model from the baseline IT-OT model.

15. A system for preventing security attacks with a virtualization of power substation physical components into an information technology-operational technology architecture, the system comprising:
a virtual system comprising a first virtual machine connected to an information technology (IT) environment of a power substation network and further comprising a second virtual machine connected to an operational technology (OT) environment of the power substation network; and
memory coupled to processing circuitry, wherein the processing circuitry is configured to:
identify, by the virtual system, an alert indicative of a potential security attack;
retrieve, by the virtual system, based on a memory access shared by the first virtual machine and the second virtual machine, IT analytics data associated with a device indicated in the alert;
retrieve, by the virtual system, based on the memory access, OT analytics data associated with the device;
compare, by the virtual system, the IT analytics data and the OT analytics data to a baseline IT-OT model of the power substation network, wherein the baseline IT-OT model is based on IT baseline analytics data and OT baseline analytics data shared between the first virtual machine and the second virtual machine by using the memory access; and
prevent, by the virtual system, communication with the device based on the comparing.

16. The system of claim 15, wherein the alert is a new node alert indicating that the device is new to the power substation network or was previously unidentified in the power substation network.

17. The system of claim 15, wherein the alert is a new communication link alert indicating that the device has requested a new communication link.

18. The system of claim 15, wherein the alert is a new protocol alert indicating that the device is using a protocol that has not been approved for the power substation network.

19. The system of claim 15, wherein the alert is a wrong time alert indicating that the device has reported an incorrect time.

20. The system of claim 15, wherein the processing circuitry is further configured to:
generate the IT-OT baseline model using IT area network interfaces, communication protocols, accessed ports, network traffic flows, device functionality, and device profiles; and
generate an IT-OT operational analytics model based on the IT analytics data and the OT analytics data,
wherein to compare the IT analytics data and the OT analytics data to the baseline IT-OT model comprises to compare the IT-OT operational analytics model to the baseline IT-OT model.
